(19) United States
(12) Patent Application Publication
(10) Pub. No.: US 2024/0158597 A1
(43) Pub. Date: May 16, 2024

(54) COMPOSITIONS COMPRISING E-HFO-1336MZZ AND METHYL FORMATE AND THEIR USE AS EXPANSION AGENTS FOR THERMOPLASTIC FOAM

(71) Applicant: THE CHEMOURS COMPANY FC, LLC, WILMINGTON, DE (US)

(72) Inventor: KONSTANTINOS KONTOMARIS, WILMINGTON, DE (US)

(73) Assignee: THE CHEMOURS COMPANY FC, LLC, WILMINGTON, DE (US)

(21) Appl. No.: 18/282,069

(22) PCT Filed: Jun. 9, 2022
(86) PCT No.: PCT/US2022/032753

§ 371 Date: Sep. 14, 2023

Related U.S. Application Data
(60) Provisional application No. 63/208,712, filed on Jun. 9, 2021.

(51) Int. Cl. C08J 9/14

(52) U.S. Cl. CPC C08J 9/149; C08J 9/142; C08J 9/146; C08J 2201/03; C08J 2203/12; C08J 2203/142; C08J 2203/162; C08J 2203/202; C08J 2205/044; C08J 2205/052; C08J 2323/06; C08J 2323/12; C08J 2325/06

(57) ABSTRACT

Disclosed is a process for preparing a thermoplastic polymer foam. The process includes providing a molten foamable composition including a thermoplastic polymer and a blowing agent. The blowing agent includes from about 2.0 to about 7.0 parts by weight per hundred resin of the thermoplastic polymer (phr) of 1,1,1,4,4,4-hexafluoro-2-butene (HFO-1336mzz) and from about 0.73 to about 15.37 phr of methyl formate. At least 50%, by weight, of the HFO-1336mzz is E-1,1,1,4,4,4-hexafluoro-2-butene (E-HFO-1336mzz). The thermoplastic polymer is a polystyrene homopolymer, a polystyrene copolymer, a styrene-acrylonitrile copolymer, a polyethylene, a polypropylene, or a blend thereof. The process also includes extruding the molten foamable composition to produce the thermoplastic polymer foam. The thermoplastic polymer foam has a plurality of cells with at least 80% of the cells being closed cells. The thermoplastic polymer foam is essentially free of structural defects. A thermoplastic polymer foam includes a thermoplastic polymer and a blowing agent.

### BACKGROUND INFORMATION

### Field of the Disclosure

This invention relates to the use of E-1,1,1,4,4,4-hexafluoro-2-butene (E-HFO-1336mzz) blends as blowing agents for thermoplastic polymers comprising polystyrene.

### Description of the Related Art

WO 2008/118627 (assigned to Dow Global Technologies) discloses the discovery of blowing agents that have a zero ozone depletion potential (ODP) and global warming potential (GWP) of less than 50 and solubility in alkenyl polymers, notably polystyrene, that enable these blowing agents comprising more than 50 weight percent (wt %) of the total blowing agent to produce quality foam. Table 2 of WO 2008/118627 discloses HFO-1336mzz (CF₃—CH═CH—CF₃) having a moderate solubility as compared to the Table 1 compounds. It is further disclosed that while the alkenes of Table 2 can comprise over 50 wt % of the blowing agent composition, additional blowing agent that is more soluble in the polymer is necessary to achieve quality foam (p. 15, I. 9-12). Quality foam is described as the foam having an average cell size of 0.02 to 5 mm, being close-celled, and having a density of 64 kg/m³ or less. Indicia of lack of quality are small average cell size, density greater than 64 kg/m³, high open cell content and blowholes (p. 2, I. 9-13). The quality foam is also essentially free of blowholes, which are described as being the size of multiple cell diameters and which can rupture at the foam surface to give an irregular surface (p. 2, I. 15-20). The blowholes that do not rupture can be called macrovoids, and the irregular surface caused by the rupturing blowholes is the opposite of a smooth surface (skin).

WO 2008/0154612 (assigned to E.I. Du Pont De Nemours and Company) discloses azeotropic and azeotrope-like compositions including the E stereoisomer of HFO-1336mzz and methyl formate, n-pentane, 2-methylbutane, E-1,2-dichloroethylene (E-HFO-1130), 1,1,1,3,3-pentafluoropropane (HFC-245fa), n-butane, or isobutane.

US 2011/0144216 (assigned to Honeywell International Inc.) discloses compositions including the Z stereoisomer of HFO-1336mzz and their potential uses, including as a blowing agent. US 2011/0144216 discloses blends of Z—HFO-1336mzz with hydrofluoroolefins (HFOs), hydrofluorocarbons (HFCs), hydrofluoroethers (HFEs), chlorofluorocarbons (CFCs), carbon dioxide, olefins, organic acids, alcohols, hydrocarbons, ethers, aldehydes, ketones, and others such as methyl formate.

### SUMMARY

Disclosed is a process for preparing a thermoplastic polymer foam. The process includes providing a molten foamable composition including a thermoplastic polymer and a blowing agent. The blowing agent includes from about 2.0 to about 7.0 parts by weight per hundred thermoplastic polymer resin (phr) of 1,1,1,4,4,4-hexafluoro-2-butene (HFO-1336mzz) and from about 0.73 to about 15.37 phr of methyl formate. At least 50%, by weight, of the HFO-1336mzz is E-1,1,1,4,4,4-hexafluoro-2-butene (E-HFO-1336mzz). The thermoplastic polymer is a polystyrene homopolymer, a polystyrene copolymer, a styrene-acrylonitrile copolymer, a polyethylene, a polypropylene, or a blend thereof. The process also includes extruding the molten foamable composition to produce the thermoplastic polymer foam. The thermoplastic polymer foam has a plurality of cells with at least 80% of the cells being closed cells. The thermoplastic polymer foam is essentially free of structural defects.

A thermoplastic polymer foam includes a thermoplastic polymer and a blowing agent. The thermoplastic polymer is a polystyrene homopolymer, a polystyrene copolymer, a styrene-acrylonitrile copolymer, a polyethylene, a polypropylene, or a blends thereof. The thermoplastic polymer defines a plurality of cells, where at least 80% of the cells are closed cells. The blowing agent includes from about 2.0 to about 7.0 phr of HFO-1336mzz and from about 0.73 to about 15.37 phr of methyl formate. At least 50%, by weight, of the HFO-1336mzz is E-HFO-1336mzz. The thermoplastic polymer foam is essentially free of structural defects.

### BRIEF DESCRIPTION OF THE DRAWINGS

FIG. 1 shows the solubility of blowing agents in softened polystyrene at various pressures.

### DETAILED DESCRIPTION

The thermoplastic polymer being foamed according to the present invention comprises a polystyrene, a polyethylene, or a polypropylene.

A blowing agent aids in foaming the thermoplastic polymer.

The polystyrene can be styrene homopolymer or can contain copolymerized monomer other than styrene, i.e. polystyrene copolymer. The thermoplastic polymer can also be a blend of polystyrene with other thermoplastic polymer. The other thermoplastic polymer can also be a copolymer of styrene with monomer other than styrene. A preferred monomer other than styrene is acrylonitrile. In one embodiment, the thermoplastic polymer is selected from the group consisting of polystyrene homopolymer, a polystyrene copolymer, a styrene-acrylonitrile copolymer, a polyethylene homopolymer, a polypropylene homopolymer, and blends thereof.

The polyethylene can be ethylene homopolymer or can contain copolymerized monomer other than ethylene, i.e. polyethylene copolymer.

The polypropylene can be propylene homopolymer or can contain copolymerized monomer other than propylene, i.e. polypropylene copolymer.

In some embodiments, whether the thermoplastic polymer being foamed is polystyrene or blends of polystyrene with other thermoplastic polymer, styrene is preferably the dominant polymerized monomer (unit) in the thermoplastic polymer being foamed. More preferably, the polymerized units of styrene constitute at least 70 mol %, alternatively at least 80 mol %, alternatively at least 90 mol %, or 100 mol % of the polymerized monomer units making up the thermoplastic polymer being foamed.

When the thermoplastic polymer contains styrene copolymer, the amount of other monomer copolymerized with the styrene is present such that the styrene content of the copolymer is at least 60 mol % of the copolymer, preferably at least 70 mol %, or at least 80 mol % or at least 90 mol % of the copolymer, based on the total mols (100%) making up the copolymer. This applies whether the styrene copolymer is the only styrene-containing polymer in the thermoplastic polymer or is a blend with other thermoplastic polymer, such as styrene homopolymer or other styrene copolymer.

In some embodiments, the thermoplastic polymer being foamed is entirely polystyrene, notably a styrene homopolymer. When the thermoplastic polymer being foamed is a blend of polystyrene and other thermoplastic polymer as described above, the polystyrene component of this blend is preferably styrene homopolymer constituting at least 80 wt % of the combined weight of polystyrene and other thermoplastic polymer.

The molecular weight of the thermoplastic polymer being foamed is sufficiently high to provide the strength necessary for the requirements of the foam application. The strength requirement determines the minimum density of the foamed product. The high molecular weight of the thermoplastic polymer also contributes to the strength of the foamed product. An indicator of molecular weight is the rate at which the molten polymer flows through a defined orifice under a defined load. The lower the flow, the higher the molecular weight. Measurement of the melt flow rate is determined in accordance with ASTM D 1238 at 200° C. and using a 5 kg weight on the molten polymer. The weight of molten polymer flowing through the orifice in a defined amount of time enables the melt flow rate to be reported in g/10 min. Preferably the melt flow rate of the thermoplastic polymer is no greater than 20 g/10 min, more preferably no greater than 15 g/10 min, and most preferably, no greater than 10 g/10 min.

In one embodiment, the minimum melt flow rate for all the melt flow rates disclosed herein is at least 1 g/10 min, whereby the melt flow rate ranges disclosed herein are 1 to 25, 1 to 20, 1 to 15, 1 to 10, 2 to 8, 2 to 6, or 3 to 5, all values being g/10 min.

The references to thermoplastic polymer comprising polystyrene also apply to polystyrene by itself. Thus, for example, the disclosure of thermoplastic polymer comprising polystyrene can be replaced by the disclosure of polystyrene.

It has been unexpectedly discovered that blowing agents containing E-1,1,1,4,4,4-hexafluoro-2-butene (E-HFO-1336mzz) and methyl formate (MF) have a solubility in the thermoplastic polymers used in the present compositions that is significantly higher than the solubility in the same polymers of the same blowing agent but without MF. One benefit of this unexpected solubility is that blowing agents of blends including E-HFO-1336mzz and MF enable stable extrusion processes for forming high quality foams.

HFO-1336mzz is present in the thermoplastic polymer foam in an amount of at least 2.0 parts by weight per hundred of the thermoplastic polymer resin (phr). As used herein, phr refers to the weight of the blowing aid or blowing aid component per hundred weight of the thermoplastic polymer resin. As used herein, mhr refers to the moles of the blowing aid or blowing aid component per hundred grams of the thermoplastic polymer resin.

At least 50 wt % of the HFO-1336mzz is E-HFO-1336mzz, such as, for example, at least 60 wt %, at least 70 wt %, at least 75 wt %, at least 80 wt %, at least 90 wt %, at least 95 wt %, at least 99 wt %, or essentially all of the HFO-1336mzz being E-HFO-1336mzz. The remaining HFO-1336mzz, when less than essentially all of the HFO-1336mzz is E-HFO-1336mzz, is Z-1,1,1,4,4,4-hexafluoro-2-butene (Z—HFO-1336mzz).

The HFO-1336mzz is preferably present in the thermoplastic polymer foam in an amount in the range of about 2.0 to about 7.0 phr, more preferably in the range of about 3.0 to about 5.0 phr.

The MF is present in the thermoplastic polymer foam in an amount of at least 0.73 phr, preferably in the range of about 0.73 phr to about 15.37 phr, more preferably in the range of about 1.65 phr to about 9.15 phr. The methyl formate is preferably selected to be at a mole ratio with respect to the E-HFO-1336mzz in the range of about 2.0 to about 6.0, more preferably in the range of about 3.0 to about 5.0.

In some embodiments, the blowing agent is essentially free of 1,1-difluoroethane (HFC-152a). In other embodiments, the blowing agent further comprises HFC-152a. The HFC-152a, when present, is preferably present in the thermoplastic polymer in an amount of up to about 4.0 phr, more preferably in the range of about 1.0 phr to about 3.0 phr.

The total amount of blowing agent in the thermoplastic polymer is at least 2.73 phr, preferably in the range of about 2.73 phr to about 25.37 phr, more preferably in the range of about 4.65 to about 17.15 phr.

The blowing agent includes about 21 to about 74 wt % of HFO-1336mzz, about 13 to about 69 wt % of methyl formate, and 0 to about 52 wt % of HFC-152a, preferably about 26 to about 64 wt % of HFO-1336mzz, about 22 to about 65 wt % of methyl formate, and 0 to about 39 wt % of HFC-152a. Of particular note are blowing agent compositions containing minimal or essentially no HFC-152a.

In some embodiments, the blowing agent includes about 31 to about 74 wt % of HFO-1336mzz and about 27 to about 69 wt % of methyl formate, preferably about 35 to about 64 wt % of HFO-1336mzz and about 35 to about 65 wt % of methyl formate.

In some embodiments, the blowing agent includes about 21 to about 56 wt % of HFO-1336mzz, about 13 to about 61 wt % of methyl formate, and about 12 to about 52 wt % of HFC-152a, preferably about 26 to about 46 wt % of HFO-1336mzz, about 22 to about 53 wt % of methyl formate, and about 17 to about 39 wt % of HFC-152a.

In some embodiments, at least 95 wt % of the blowing agent is the combined amount of E-HFO-1336mzz and MF, alternatively at least 98% by weight, or alternatively at least 99% by weight of the blowing agent.

In some embodiments, at least 95 wt % of the blowing agent is the combined amount of E-HFO-1336mzz, Z—HFO-1336mzz, and MF, alternatively at least 98% by weight, or alternatively at least 99% by weight of the blowing agent.

In some embodiments, at least 95 wt % of the blowing agent is the combined amount of E-HFO-1336mzz, HFC-152a, and MF, alternatively at least 98% by weight, or alternatively at least 99% by weight of the blowing agent.

In some embodiments, at least 95 wt % of the blowing agent is the combined amount of E-HFO-1336mzz, Z—HFO-1336mzz, HFC-152a, and MF, alternatively at least 98% by weight, or alternatively at least 99% by weight of the blowing agent.

In some embodiments, the blowing agent blend is an azeotropic or near azeotropic composition. In other embodiments, the blowing agent blend is not an azeotropic or near azeotropic composition.

In some embodiments, the blowing agent blend may further include other compounds, which may include, but are not limited to, hydrocarbons, hydrofluoroolefins, or hydrofluorocarbons.

In one embodiment, a foam product comprises a polymer matrix comprising a thermoplastic material selected from the group consisting of polystyrene, polystyrene copolymers, styrene-acrylonitrile copolymer, polyethylene, polypropylene, and blends thereof, defining a plurality of cells having an average cell size of at least 0.10 mm, and a blowing agent comprising E-HFO-1336mzz and MF.

In other embodiments, the molten composition being foamed can contain additives other than the polymer being foamed and the E-HFO-1336mzz blowing agent, such as co-blowing agent, nucleating agent, flame retardant, cell stabilizer agent, surfactant, preservative colorant, antioxidant, reinforcing agent, filler, antistatic agent, infrared (IR) attenuating agent, extrusion aid, plasticizer, viscosity modifier, and other known additives, all in the amount to obtain the effect desired. The present invention is not limited to any particular additive, except as may be specified in any claim appended hereto.

Examples of preferred nucleating agent include talc, graphite, and magnesium silicate.

Examples of preferred flame retardants include tetrabromo-bis phenol A and polymeric flame retardants.

The molten composition is in effect the foamable composition. The amount of blowing agent in the molten composition will depend on the amount of additives other than blowing agent and the density desired in the foamed product. In one embodiment, the amount of blowing agent, will be from 0.01 to 0.2 moles of blowing agent per 100 grams of the thermoplastic polymer resin (mhr). In another embodiment, the amount of blowing agent will be from 0.05 to 0.15 mhr. In another embodiment, the amount of blowing agent will be from 0.08 to 0.12 mhr. In various embodiments, this can vary depending on the desired density of the foam, and the composition of the blowing agent. In some embodiments, the amount of blowing agent is in the range of 0.024 to 0.344 mhr, preferably in the range of 0.046 to 0.228 mhr.

In one embodiment, a foaming process is carried out using an extruder to form the molten composition and to extrude it to form the foamed product. The thermoplastic polymer forms the feed to the extruder. The blowing agent(s) is (are) preferably fed into the extruder at a location intermediate to the feed and extrusion ends of the extruder, typically into the molten composition that is created as the extrusion screw advances the feeds to the extruder along its length. The other additives to the molten composition are added where convenient and as may be dictated by the state of the additive. For example, solid additives can be conveniently added to the feed end of the extruder, possibly as a mixture with the polymer feed in particulate form to the extruder. The molten composition within the extruder is extruded through a die, thereby allowing the foamable composition to expand into a foamed product. The foamed product, which can be in such forms as sheet, plank, rod, or tube, is then cooled.

In the region within the extruder where the composition is melted to form the molten composition, this melting occurs by the input of heat and the heat developed in the mixing process forming the melt. This is considered the melt mixing region of the extruder. In one embodiment, the temperature is at least 185° C., more preferably at least 190° C. or at least 200° C. or at least 210° C. in this melt mixing region. In another embodiment, the maximum temperature for all the melt mixing temperatures disclosed herein is 250° C. The melt mixing temperatures disclosed herein are the temperatures of the melt in the mixing zone at the time of mixing. In one embodiment, the pressure under which the melt mixing is carried out is at least 2000 psi (138 Bar), preferably at least 3000 psi (207 Bar), more preferably at least 4000 psi (276 Bar). In one embodiment, the maximum value for all the minimum pressures disclosed under which the melt mixing is carried out is no greater than 5000 psi (345 Bar). The pressures disclosed herein are gauge pressures.

In the region within the extruder where the molten composition is extruded, the molten composition is cooled so that the temperature at which the extrusion is carried out is preferably at least 100° C., more preferably at least 110° C., more preferably at least 120° C., and even more preferably at least 125° C. In one embodiment, the maximum value for all the minimum extrusion temperatures disclosed herein is preferably no greater than 140° C. The extrusion temperatures disclosed herein are the temperature of the melt at the time of extrusion.

In one embodiment, the extrusion is carried out at a pressure of at least 700 psi (48 Bar), preferably at least 1000 psi (69 Bar), more preferably at least 1300 psi (90 Bar). The maximum value for the minimum extrusion pressures disclosed herein is preferably no greater than 2000 psi (138 Bar). The extrusion pressure is the pressure inside the extrusion die.

The disclosures of multiple ranges for melt flow rate, temperature, and pressure above can be used in any combination in the practice of the present invention to obtain the particular foamed structure desired. For example, melt mixing pressures of 2000 to 5000 psi (138 to 345 Bar) are preferred for achieving low foam densities of the foamed product, and this pressure range can be used with any of the melt mixing and extrusion temperature ranges to form any of the smooth-skin, closed cell foam product densities disclosed herein. The same is true for the melt extrusion pressure range of 700 to 2000 psi (48 to 138 Bar) together with the 3000 to 5000 psi (207 to 345 Bar) pressure range for melt mixing. Most preferably, the two preferred pressure ranges, for melt mixing (138 Bar to 345 Bar) and extrusion (48 to 138 Bar) are used together. The melt flow rates for the polymer being foamed of no greater than 25, 20, 15, and 10, and as little as at least 1, all values being in g/10 min, can be used with any of these combinations of pressure and temperatures, depending on the foamed product result desired.

Preferably the extruded thermoplastic polymer foam and blowing agent exhibits at least one, more than one, or all of the following four foamed product attributes:
(1) The thermoplastic polymer foam has an HFO-1336mzz concentration of about 2.0 phr or greater, so as to meet long-term foam thermal resistance targets, where at least 50%, by weight, of the HFO-1336mzz is E-HFO-1336mzz.
(2) The thermoplastic polymer foam has a good foam quality in that it is essentially free of structural defects, including, but not limited to, foam collapse and blowholes of a size exceeding multiple cell diameters.
(3) The thermoplastic polymer foam has an average foam cell diameter greater than 0.10 mm, preferably greater than 0.15 mm.
(4) The thermoplastic polymer foam has at least 80% closed cells, preferably at least 90%, and more preferably at least 95%. Closed cell content can be measured according to ASTM method D6226-05.

In some embodiments, the extruded thermoplastic polymer foam and blowing agent has a density no greater than about 40 kg/m³ and more preferably no greater than about 35 kg/m³ or about 25 kg/m³. Density can be measured according to ISO method 845-85. In some embodiments, the minimum required strength (compressive) of the foamed product will dictate that the density be at least 16 kg/m³.

Preferably the thermoplastic polymer foam is formed by a process comprising extruding a molten composition comprising thermoplastic polymer and blowing agent comprising E-HFO-1336mzz and MF. Preferably the extrusion is carried out at a temperature of at least 100° C., more preferably at least 120° C., or even more preferably at least 125° C., and under a pressure of at least 700 psi, more preferably at least 1000 psi, or even more preferably at least 1300 psia, and obtaining as a result thereof a closed cell, defect-free foamed thermoplastic polymer. The extrusion temperatures disclosed herein are the temperatures of the melt at the time of extrusion. The extrusion pressures are the pressures inside the extrusion die.

As used herein, the terms “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The transitional phrase “consisting of” excludes any element, step, or ingredient not specified. If in the claim, such language would close the claim to the inclusion of materials other than those recited except for impurities ordinarily associated therewith. When the phrase “consists of” appears in a clause of the body of a claim, rather than immediately following the preamble, it limits only the element set forth in that clause, other elements are not excluded from the claim as a whole. The transitional phrase “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term “consisting essentially of” occupies a middle ground between “comprising” and “consisting of”.

Where applicants have defined an invention or a portion thereof with an open-ended term such as “comprising”, it should be readily understood that (unless otherwise stated) the description should be interpreted to also include such an invention using the terms “consisting essentially of” or “consisting of”.

### EXAMPLES

The invention will be described in greater detail by way of specific examples. The following examples are offered for illustrative purposes and are not intended to limit the invention in any manner.

### Example 1

### Solubility of E-HFO-1336mzz/HFC-152a/Methyl Formate Blends in Softened Polystyrene Homopolymer

The solubility of neat E-HFO-1336mzz (Comparative Example 1), a blend of 50 wt % E-HFO-1336mzz and 50 wt % HFC-152a (Comparative Example 2), a blend of 40 wt % E-HFO-1336mzz, 40 wt % HFC-152a, and 20 wt % methyl formate (Inventive Example 1), and of a reference fluid (FormaceI™ Z-6) of 41 wt % HFC-134a, 9 wt % HFC-134, and 50 wt % HFC-152a (Comparative Example 3) in softened polystyrene was assessed.

A 78 gram polystyrene homopolymer sample was loaded into a 125-cc stainless steel reactor (Parr Instrument Company, Moline, IL). The thermoplastic polymer is preferably high in molecular weight as indicated by it exhibiting a melt flow rate (sometimes called MFR or MFI) of no greater than 25 g/10 min as determined in accordance with the procedure of ASTM D 1238 at 200° C. using a 5 kg weight on the molten polymer.

The reactor was weighed, mounted to inlet/outlet piping, immersed in an oil bath, and evacuated. The reactor was loaded with an amount of blowing agent in excess of its expected solubility using an HiP pressure generator (Graco High Pressure Equipment Inc., Erie, PA). The oil bath was heated to 179° C. in about 90 minutes and was then kept at 179° C. for 30 minutes. The system pressure was monitored and the final pressure, analogous to the pressure in an extruder used in the foaming process, was recorded. The reactor was removed from the oil bath and cooled to room temperature. The reactor (with re-solidified polystyrene inside) was weighed after excess blowing agent (non-dissolved in the polystyrene) was drained or vented. The solubility of a fluid was quantified as the increase of the weight of a softened polystyrene sample resulting from the absorption of the selected blowing agent fluid at the selected temperature of 179° C. and at the recorded final pressure, in parts per hundred of the thermoplastic polymer resin (phr) according to Equation (1).

solubility(phr)=(weight gain+78)×100 (1)

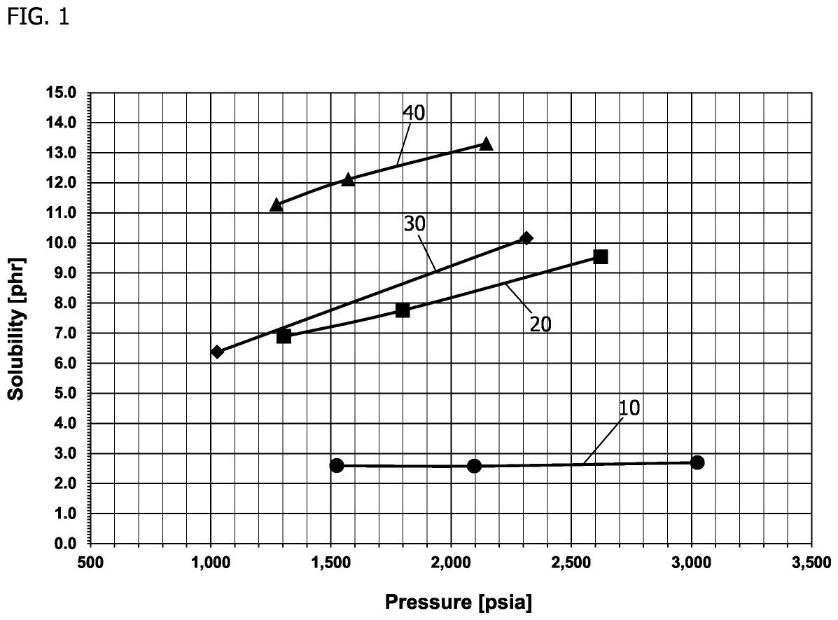

FIG. 1 shows the enhanced solubility of Inventive Example 1 (40) in softened polystyrene compared to the solubility of Comparative Example 1 (10), Comparative Example 2 (20), and Comparative Example 3 (30) in softened polystyrene.

FIG. 1 shows that, unexpectedly, a blend of E-HFO-1336mzz with HFC-152a and methyl formate (MF) can have solubility in softened polystyrene that significantly exceeds the solubility, at the same conditions, of neat E-HFO-1336mzz and of an E-HFO-1336mzz blend with HFC-152a.

The solubility of Comparative Example 1 in softened polystyrene homopolymer with a Melt Flow Index (MFI) of 5.0 g/10 min at 179° C. and 1,557 psia was measured as 2.6 g per 100 g of polystyrene (or 2.6 phr).

The solubility of Comparative Example 2 in the same polystyrene and at the same temperature (179° C.) and pressure (1,557 psia) conditions was measured as 7.3 g per 100 g of polystyrene (or 7.3 phr).

In contrast, the solubility of Inventive Example 1 in the same polystyrene and under the same temperature (179° C.) and pressure (1,557 psia) conditions was measured as 12.0 g per 100 g of polystyrene (or 12.0 phr), i.e. higher than the solubility of neat E-HFO-1336mzz by more than 367% and higher than the solubility of the 50/50 wt % E-HFO-1336mzz/HFC-152a blend by more than 64%.

For reference, the solubility of an incumbent extruded polystyrene (XPS) blowing agent, namely FormaceI™ Z-6 (Comparative Example 3), in the same polystyrene and under the same temperature (179° C.) and pressure (1,557 psia) conditions was measured as 7.9 g per 100 g of polystyrene (or 7.9 phr).

Therefore, the solubility of Inventive Example 1 was higher than the solubility of the incumbent XPS blowing agent, under comparable conditions, by more than 52%.

### Example 2

### Polystyrene Foam Extrusion Using E-HFO-1336mzz/Methyl Formate Blends as the Blowing Agent and Containing Greater than 2.9 Phr E-HFO-1336mzz

The effectiveness of blends of E-HFO-1336mzz and HFC-152a (Comparative Examples 4-6), neat methyl formate (Comparative Example 7), and a blend of E-HFO-1336mzz and methyl formate (Inventive Example 2) as blowing agents for polystyrene was assessed.

The blowing agent in Comparative Example 4 (CE4) included about 22 wt % E-HFO-1336mzz and about 78 wt % HFC-152a. The blowing agent in Comparative Example 5 (CE5) included about 33 wt % E-HFO-1336mzz and about 67 wt % HFC-152a. The blowing agent in Comparative Example 6 (CE6) included about 39 wt % E-HFO-1336mzz and about 61 wt % HFC-152a. The nucleating agent (nucleator), namely talc in Comparative Example 7 (CE7), was present along with the polystyrene and blowing agent in the molten composition formed within the extruder. The blowing agent in Inventive Example 2 (IE2) included about 38 wt % E-HFO-1336mzz and about 62 wt % HFC-152a. The total amount of blowing agent in Table 1 is given as moles of blowing agent per 100 grams of polystyrene (mhr). The polystyrene was styrene homopolymer available from Total Petrochemicals as PS 535B having a melt flow rate of 4 g/10 min.

A 50-mm twin screw laboratory extruder was used to extrude the polystyrene with nine individually controlled, electrically heated zones. The first four zones of the extruder were used to heat and soften the polymer. The remaining barrel sections, from the blowing agent injection location to the end of the extruder, were set at selected lower temperatures. An annular die with a 3 mm opening was used in extruding foamed rod specimens. Table 1 shows the extruder operating parameters and the resulting properties of the extruded polystyrene, including the four previously-mentioned foam product attributes.

TABLE 1
Extruder Operating Parameters and Foam Properties Achieved

| Example | CE4 | CE5 | CE6 | CE7 | IE2 |
|---|---|---|---|---|---|
| E-HFO-1336-mzz (phr) | 1.7 | 2.6 | 3.4 | 0.0 | 3.2 |
| HFC-152a (phr) | 5.9 | 5.4 | 5.6 | 0.0 | 0.0 |
| Methyl formate (phr) | 0.0 | 0.0 | 0.0 | 4.2 | 5.1 |
| Total blowing agent (mhr) | 0.100 | 0.097 | 0.106 | 0.069 | 0.104 |
| Extrusion temperature (° C.) | 135 | 128 | 135 | 131 | 122 |
| Extrusion pressure (psi) | 1000 | 1540 | 1070 | 2100 | 1600 |
| Extruder speed (rpm) | 40 | 40 | 40 | 40 | 40 |
| Polystyrene flow rate (kg/hr) | 20 | 20 | 20 | 20 | 20 |
| Nucleator in feed (wt %) | 0 | 0 | 0 | 0 | 0 |
| Foam quality | Good | Poor¹ | Poor² | Poor³ | Good |
| Avg. cell diameter (mm) | 0.174 | 0.062 | <0.050 | N/A | 0.193 |
| Closed cells (%) | 96 | 49 | 22 | N/A | 97 |

¹Blow holes were present
²Blow holes were present; unstable extrusion operation
³After initial expansion, foam collapsed upon cooling

HFC-152a has been demonstrated as an effective co-blowing agent for incumbent XPS foam blowing agents, including FormaceI™ Z-6 (HFC-134/HFC-134a/HFC-152a; 9/41/50 wt %) and Opteon™ 1000 (Z—HFO-1336mzz)/HFC-152a blends (see, for example, U.S. Pat. App. Pub. No. 2018/0327565, which is hereby incorporated by reference). Efforts to extrude polystyrene foam with E-HFO-1336mzz/HFC-152a blends as the blowing agent failed to identify a set of operating conditions (in the range of conditions practiced with incumbent blowing agents) that enables the production of foam having predetermined attributes. Values in Table 1 denoted in bold failed to have the predetermined attributes. As the level of E-HFO-1336mzz was increased from Comparative Example 4 to Comparative Example 5 to Comparative Example 6, the foam quality deteriorated.

Methyl formate (MF) was also evaluated as a co-blowing agent for E-HFO-1336mzz. Efforts to extrude polystyrene foam with neat MF as the blowing agent failed to identify a set of operating conditions (in the range of conditions practiced with incumbent blowing agents) that enables the production of foam meeting the predetermined attributes, as shown by Comparative Example 7.

E-HFO-1336mzz/MF blends were, surprisingly, found effective as blowing agents in enabling polystyrene foam meeting the predetermined attributes, as shown by Inventive Example 2, under extrusion operating conditions similar to those for which neat E-HFO-1336mzz, neat methyl formate, and E-HFO-1336mzz/HFC-152a blends were found to be ineffective. This demonstrates the capacity of E-HFO-1336mzz/methyl formate blends as the blowing agent to produce polystyrene foam insulation containing greater than 2.9 phr of E-HFO-1336mzz that is essentially free of structural defects, with an average cell diameter of greater than 0.10 mm and with a closed cell content exceeding 80%. Macrovoids and blowholes were not present in the foam insulation of Inventive Example 2.

### Example 3

### Extrusion of Polystyrene Foam Using E-HFO-1336mzz/Z—HFO-1336mmz/HFC-152a/Methyl Formate Blends as the Blowing Agent Containing 5.0 Phr of HFO-1336mzz

The capacity of blends of E-HFO-1336mzz, HFC-152a, and methyl formate (Comparative Example 8) and of E-HFO-1336mzz, Z—HFO-1336mzz, HFC-152a, and methyl formate (Inventive Example 3) as blowing agents for polystyrene was assessed.

The blowing agent in Comparative Example 8 (CE8) included about 53 wt % E-HFO-1336mzz, about 6 wt % HFC-152a, and about 41 wt % methyl formate. The blowing agent in Inventive Example 3 (IE3) included about 26.5 wt % E-HFO-1336mzz, about 26.5 wt % Z—HFO-1336mzz, about 6 wt % HFC-152a, and about 41 wt % methyl formate. The polystyrene was the same as used in Example 2.

The same 50-mm twin screw laboratory extruder as in Example 2 was used to extrude the polystyrene. Table 2 shows the extruder operating parameters and the resulting properties of the extruded polystyrene foam.

TABLE 2
Extruder Operating Parameters and Foam Properties Achieved

| Example | CE8 | IE3 |
|---|---|---|
| E-HFO-1336-mzz (phr) | 4.9 | 2.5 |
| Z-HFO-1336-mzz (phr) | 0.0 | 2.5 |
| HFC-152a (phr) | 0.6 | 0.6 |
| Methyl formate (phr) | 3.8 | 3.8 |
| Total blowing agent (mhr) | 0.103 | 0.102 |
| Extrusion temperature (° C.) | 125 | 130 |
| Extrusion pressure (psi) | 1440 | 1050 |
| Extruder speed (rpm) | 40 | 40 |
| Polystyrene flow rate (kg/hr) | 20 | 20 |
| Foam quality | Poor | Good |
| Average cell diameter (mm) | 0.056 | 0.193 |
| Closed cells (%) | 39 | 93 |

As shown in Table 2, Comparative Example 8, a blend containing the E stereoisomer but not the Z stereoisomer of HFO-1336mzz, provided extruded polystyrene containing about 5 phr of E-HFO-1336mzz, but was otherwise ineffective as a blowing agent in enabling the production of polystyrene foam meeting predetermined attributes for foam quality, cell diameter, and percent of closed cells under extrusion operating conditions in the range of conditions practiced with incumbent blowing agents.

As shown in Table 2, Inventive Example 3, a blend containing equal amounts of the E stereoisomer and the Z stereoisomer of HFO-1336mzz, was, surprisingly, found to be effective as a blowing agent in enabling the production of polystyrene foam meeting predetermined attributes for foam quality, cell diameter, and percent of closed cells under extrusion operating conditions similar to those for which Comparative Example 8 was found to be ineffective.

What is claimed is:

1. A process for preparing a thermoplastic polymer foam, comprising:
(a) providing a molten foamable composition comprising a thermoplastic polymer and a blowing agent, wherein said blowing agent comprises from about 2.0 to about 7.0 parts by weight per hundred resin of the thermoplastic polymer (phr) of 1,1,1,4,4,4-hexafluoro-2-butene (HFO-1336mzz) and from about 0.73 to about 15.37 phr of methyl formate, wherein at least 50%, by weight, of the HFO-1336mzz is E-1,1,1,4,4,4-hexafluoro-2-butene (E-HFO-1336mzz), and wherein said thermoplastic polymer is selected from the group consisting of a polystyrene homopolymer, a polystyrene copolymer, a styrene-acrylonitrile copolymer, a polyethylene, a polypropylene, and blends thereof;
(b) extruding said molten foamable composition to produce said thermoplastic polymer foam, the thermoplastic polymer foam having a plurality of cells with at least 80% of the cells being closed cells;
wherein the thermoplastic polymer foam is essentially free of structural defects.

2. The process of claim 1, wherein said thermoplastic polymer is polystyrene homopolymer.

3. The process of claim 1, wherein said thermoplastic polymer is a polyethylene.

4. The process of claim 1, wherein said thermoplastic polymer is a polypropylene.

5. The process of claim 1 wherein said molten foamable composition further comprises a nucleating agent.

6. The process of claim 1, wherein said molten foamable composition further comprises a flame retardant.

7. The process of claim 1, wherein the thermoplastic polymer foam has an average cell diameter of at least 0.10 mm.

8. The process of claim 1, wherein the extruding occurs at a temperature of at least 100° C.

9. The process of claim 1, wherein the extruding occurs at a pressure of at least 700 psi.

10. The process of claim 1, wherein the thermoplastic polymer has a melt flow rate of less than 25 g/10 min.

11. The process of claim 1, wherein at least 95%, by weight, of the HFO-1336mzz is E-HFO-1336mzz.

12. The process of claim 1, wherein essentially all of the HFO-1336mzz is E-HFO-1336mzz.

13. The process of claim 1, wherein the blowing agent comprises from about 3.0 to about 5.0 phr of HFO-1336mzz and from about 1.65 to about 9.15 phr of methyl formate.

14. The process of claim 1, wherein the blowing agent is essentially free of 1,1-difluoroethane (HFC-152a).

15. The process of claim 1, wherein the blowing agent further comprises up to about 4.0 phr of 1,1-difluoroethane (HFC-152a).

16. The process of claim 1, wherein the blowing agent is present in an amount from about 2.73 to about 25.37 phr.

17. The process of claim 1, wherein a molar ratio of the methyl formate to the E-HFO-1336mzz is in the range of about 2.0 to about 6.0.

18. A thermoplastic polymer foam comprising a thermoplastic polymer and a blowing agent, wherein:
said thermoplastic polymer is selected from the group consisting of a polystyrene homopolymer, a polystyrene copolymer, a styrene-acrylonitrile copolymer, a polyethylene, a polypropylene, and blends thereof;
said thermoplastic polymer defines a plurality of cells, at least 80% of the cells being closed cells;
said blowing agent comprises from about 2.0 to about 7.0 parts by weight per hundred resin of the thermoplastic polymer (phr) of 1,1,1,4,4,4-hexafluoro-2-butene (HFO-1336mzz) and from about 0.73 to about 15.37 phr of methyl formate;
at least 50%, by weight, of the HFO-1336mzz is E-1,1,1,4,4,4-hexafluoro-2-butene (E-HFO-1336mzz); and
said thermoplastic polymer foam is essentially free of structural defects.

19. The thermoplastic polymer foam of claim 18, wherein said thermoplastic polymer is polystyrene homopolymer.

20. The thermoplastic polymer foam of claim 18, wherein said thermoplastic polymer is a polyethylene.

21. The thermoplastic polymer foam of claim 18, wherein said thermoplastic polymer is a polypropylene.

22. The thermoplastic polymer foam of claim 18 further comprising a nucleating agent.

23. The thermoplastic polymer foam of claim 18 further comprising a flame retardant.

24. The thermoplastic polymer foam of claim 18 further comprising an infrared attenuating agent.

25. The thermoplastic polymer foam of claim 17, wherein the thermoplastic polymer foam has an average cell diameter of at least 0.10 mm.

26. The thermoplastic polymer foam of claim 17, wherein the thermoplastic polymer has a melt flow rate of less than 25 g/10 min.

27. The thermoplastic polymer foam of claim 17, wherein at least 95%, by weight, of the HFO-1336mzz is E-HFO-1336mzz.

28. The thermoplastic polymer foam of claim 17, wherein essentially all of the HFO-1336mzz is E-HFO-1336mzz.

29. The thermoplastic polymer foam of claim 17, wherein the blowing agent comprises from about 3.0 to about 5.0 phr of HFO-1336mzz and from about 1.65 to about 9.15 phr of methyl formate.

30. The thermoplastic polymer foam of claim 17, wherein the blowing agent is essentially free of 1,1-difluoroethane (HFC-152a).

31. The thermoplastic polymer foam of claim 17, wherein the blowing agent further comprises up to about 4.0 phr of 1, 1-difluoroethane (HFC-152a).

32. The thermoplastic polymer foam of claim 17, wherein the blowing agent is present in an amount from about 2.73 to about 25.37 phr.

33. The thermoplastic polymer foam of claim 17, wherein a molar ratio of the methyl formate to the E-HFO-1336mzz is in the range of about 2.0 to about 6.0.
